(19) United States
(12) Patent Application Publication
(10) Pub. No.: US 2026/0106517 A1
(43) Pub. Date: Apr. 16, 2026

(54) DEVICE AND METHOD FOR CONTROLLING MOVEMENTS OF AN OBJECT IN AN OPEN- AND/OR CLOSED-LOOP MANNER

(71) Applicant: MICRO-EPSILON-MESSTECHNIK GMBH & CO. K.G., Ortenburg (DE)

(72) Inventors: Tobias Schopf, Ortenburg (DE); Teodora Sigalova-Grabl, Ortenburg (DE); Günter Schallmoser, Ortenburg (DE)

(21) Appl. No.: 19/116,284

(22) PCT Filed: Jul. 31, 2023
(86) PCT No.: PCT/DE2023/200158

§ 371 Date: Mar. 27, 2025

(30) Foreign Application Priority Data
Oct. 26, 2022 (DE) 10 2022 211 380.2

(51) Int. Cl. H02K 11/21; H02K 1/12; H02K 1/22; H02K 3/04

(52) U.S. Cl. CPC H02K 11/21; H02K 1/12; H02K 1/22; H02K 3/04

(57) ABSTRACT

In respect of high dynamics at high accuracy and low energy consumption, the invention specifies a device for controlling movements of an object in an open-and/or closed-loop manner, wherein the device has an electromagnetic actuator (2), designed to move the object, with a stator (3) and with a rotor (4) coupled to the stator (3), in an electromagnetically interacting manner, for generating the movement and coupled to the object or supporting the object, a flexure (7, 12) that guides and/or supports the rotor (4) and at least one sensor (13) for detecting a movement of the rotor (4) and/or of the object, wherein a sensor signal of the at least one sensor (13) generated on the basis of a movement of the rotor (4) and/or of the object can be used to control a position of the rotor (4) in an open-and/or closed-loop manner. The invention also relates to a corresponding method.

### CROSS REFERENCE TO RELATED APPLICATIONS

This application is a National Stage Application, filed under 35 U.S.C. § 371, of International Application No. PCT/DE2023/200158, filed Jul. 31, 2023, which international application claims priority to and the benefit of German Application No. 10 2022 211 380.2, filed Oct. 26, 2022; the contents of both of which as are hereby incorporated by reference in their entireties.

### BACKGROUND

### Technical Field

The present invention relates to a device and a method for controlling movements of an object in an open-and/or closed-loop manner.

### Description of Related Art

Such a device is known, for example, in the form of an actuator-sensor system, which can be used in numerous areas of technology for controlling movements in a monitored manner. Such systems require particularly high dynamics when they are used in optical applications. For example, very fast actuators are required for laser processing in order to guide the laser beam quickly over a workpiece to be processed. Fast actuators are also used in metrology, e.g., to scan surfaces. Another area of application is laser communication, where lasers are used to communicate between moving objects (e.g., aircraft, satellites). Here it is necessary to track the laser beam of the (possibly moving) transmitter very quickly and reliably to the (possibly also moving) receiver.

A variety of electromagnetic actuators are available for such applications, which are based in principle on the Lorentz force or reluctance force. These actuators are used to move optical elements that can shape or deflect light beams. For example, tilting mirrors (also known as “fast-steering mirrors (FSM)”) are often used for scanning movements. The optical element is usually connected to the rotor of the actuator system and is therefore part of the moving mass in this system. Since optical elements are usually made of glass, the mass to be moved for shaping or deflection cannot be neglected. The challenge is therefore to move optical elements—lenses, mirrors, prisms, etc.—very quickly and in a targeted manner. Due to their low cost, so-called voice coil actuators are often used for this purpose.

The mass inertia of the object to be moved by the actuator (this is usually the rotor together with the optical element) is usually determined on the basis of the required optical properties of the optical element and the requirements for the stability and manufacturability of the associated mechanics. The actuator is then designed in such a way that it can apply the necessary force and dynamics to achieve the required deflection of the object with the desired dynamics. A controller is used to close a control loop so that targeted, controlled movements of the rotor and thus of the optical element are achieved. In this context, dynamic range refers to the bandwidth in closed-loop operation of the actuator-sensor system. The control bandwidth is the frequency up to which (at 3dB) interference and errors can be compensated.

Due to the moving masses, such actuators have resonant frequencies in the two-digit or low three-digit frequency range. The fundamental frequency is determined by the moving mass m and the spring constant-stiffness-c of the system according to the basic formula ω=√c/m (1). In rotary actuator-sensor systems, the moment of inertia J can also be selected instead of the mass m to determine the resonant frequencies according to the formula ω=V(c/J). In more complex systems, higher harmonics occur in addition to the fundamental frequency.

In closed-loop-controlled systems, the fundamental frequency is usually not a problem for the control, as the controller is designed for this. The higher harmonics in the form of parasitic resonances are particularly critical, as they interfere with control since higher harmonics excite other degrees of freedom instead of the desired movement at the fundamental frequency. Interference excitations would then be inadequately controlled and positive feedback (oscillation) could occur and the entire system could become unstable.

This means that the open-loop transfer function (i.e., the transfer function in uncontrolled operation) should be smooth at the control bandwidth and not contain any undesirable parasitic resonances. The actuator-sensor system must then be designed in such a way that the higher harmonics (parasitic resonances or modes) only lie above the control bandwidth. This would achieve a linear transmission behavior up to the desired (−3 dB) bandwidth (dynamic) of the overall system. For very dynamic systems, for example for optical applications, this means that the control bandwidth must be in a high range, for example at 1.5 kHz or 2 kHz. In order for the parasitic modes to lie above the control bandwidth, this would also require a very high fundamental frequency, for example 400 to 500 Hz. A high fundamental frequency can be achieved in two ways according to formula (1): Either the stiffness c in the system is increased, or the moving mass m (or the moment of inertia J) is reduced. However, a reduction of the mass or the moment of inertia is often not possible due to the aforementioned requirements for optical elements or mechanics, as these are predetermined. However, increasing the mechanical stiffness means that the actuator has to apply considerably more energy in order to control the stiffer system. This means that there is a high energy consumption or power loss on the actuator side.

The interaction of the elements described here is complex: mechanical elements must be coupled with magnetic elements and controlled with an electromagnetic actuator to move optical elements. Then there are the sensors to create a closed control loop.

### BRIEF SUMMARY

The present invention addresses the problem of designing and developing a device of the type mentioned at the outset, for example an actuator-sensor system, and a corresponding method in such a way that high dynamics with high accuracy and low energy consumption are made possible.

The above problem is solved by a device and a method with the features of the appended claims.

A device for controlling movements of an object in an open-and/or closed-loop manner is then provided, wherein the device has an electromagnetic actuator, designed to move the object, with a stator and a rotor coupled to the stator, interacting electromagnetically, for generating the movement and coupled to the object or supporting the object, a flexure that guides and/or supports the rotor and at least one sensor for detecting a movement of the rotor and/or the object, wherein a sensor signal of the at least one sensor generated on the basis of a movement of the rotor and/or the object can be used to control a position of the rotor in an open-and/or closed-loop manner.

The method according to claim 17 has the following features: Method for controlling movements of an object in an open-and/or closed-loop manner, in particular by means of a device according to one of claims 1 to 16, wherein the device comprises an electromagnetic actuator designed to move the object and having a stator and a rotor coupled to the stator, in an electromagnetically interacting manner, for generating the movement and coupled to the object or supporting the object, a flexure that guides and/or supports the rotor and at least one sensor for detecting a movement of the rotor and/or the object, wherein a sensor signal of the at least one sensor generated on the basis of a movement of the rotor and/or the object is used to control a position of the rotor in an open-and/or closed-loop manner.

In accordance with the invention, it has been recognized that the above task is solved in a surprisingly simple way by the clever combination of mechanical, electrical and magnetic components within the actuator.

In a further advantageous way, the flexure can be designed with such a high stiffness that parasitic modes are above a control bandwidth, and the actuator can have such a negative stiffness that the fundamental frequency is reduced with regard to energy-efficient operation. Furthermore, the flexure can be equipped with a sufficiently high stiffness so that parasitic modes are above the control bandwidth, and the actuator with its negative stiffness reduces the fundamental frequency to such an extent that energy-efficient operation is possible.

In accordance with the invention, it has also been recognized that a high-positive-stiffness of the mechanical subsystem within an actuator-sensor system can be compensated by a negative stiffness of the electrical-magnetic subsystem. The high positive stiffness of the mechanical subsystem is necessary so that—as already explained above—parasitic modes are above the required control bandwidth. It has been recognized that the use of an electrical-magnetic subsystem can generate a negative stiffness, which virtually de-dampens the system, i.e., a low overall stiffness is achieved. The overall stiffness of the system is therefore made up of the positive stiffness of the mechanical subsystem and the negative stiffness of the electromagnetic subsystem. Surprisingly, the introduction of the negative stiffness leads to a further reduction in the fundamental frequency on the one hand, but on the other hand the parasitic modes are not or only slightly affected by this and continue to be above the control bandwidth. Reducing the fundamental frequency also reduces the energy consumption of the actuator, which means that simple and stable control with high dynamics and low energy consumption can be achieved.

In order to enable movement of the object in certain degrees of freedom, the mechanical subsystem contains certain components that enable movement in these degrees of freedom and suppress other degrees of freedom. For example, in the case of a tilting movement in one axis, movement in the tilting direction must be possible, while movements perpendicular to this or torsional movements are suppressed. In accordance with the invention, such a component is designed as a flexure, which enables movements of the rotor and thus of the object in a variety of predeterminable ways and depending on individual requirements. In general, the flexure can be a rigid body that is designed to be elastically deformable in a predefined range of movement. Thus, a flexure can be a flexible element or a combination of elements that is or are compliant or movable in a predeterminable number of degrees of freedom. Such a flexure can, for example, at least largely prevent movement in a predeterminable direction, while allowing movement in another predeterminable direction to a desired extent. This enables high dynamics with high accuracy and low energy consumption of the described device.

Depending on individual requirements and design, the stator can have at least one coil to which current can be applied. In conjunction with a ferromagnetic or permanent magnetic counterpart on the rotor, this exerts a force on the rotor, which can be used to move the object This ensures electromagnetic interaction with the rotor.

With regard to suitable amplification and guidance of a magnetic field generated with the coil, the at least one coil can have a preferably soft magnetic core.

In accordance with the invention, it has also been recognized that—depending on the individual requirements and individual configuration—the rotor can have at least one permanent magnet. With the aid of the permanent magnet, a negative rigidity of the actuator is achieved, which counteracts the positive mechanical rigidity. The result is a particularly dynamic and at the same time energy-saving movement of the rotor and thus of the object.

With regard to a simple generation of a two-axis device with a possibility of movement of the rotor and thus of the object about two axes, the stator can have two coils that are laterally offset from each other. In a particularly suitable arrangement, the at least two coils are offset by an angle of 90° so that movement is achieved in two axes offset by 90° to each other.

In order to generate a movement particularly efficiently, the stator can have two coils that are arranged opposite each other. The first coil amplifies the force effect of the permanent magnet(s), while the other coil attenuates it (differential arrangement). This results in a force or torque, which leads to a particularly efficient deflection or tilting of the rotor. For a two-axis device, two coils, two permanent magnets and two sensor elements can be used for each direction of movement.

To ensure a stable arrangement of the rotor, the flexure can have a bending element, preferably designed as a rod flexure. The movement of the rotor and thus also of the object can thus take place along a bending direction of the flexure element. A stable positioning of the rotor can be achieved along a longitudinal direction of the flexure element, which for example specifies a z-direction, so that a movement of the rotor in the longitudinal direction can be at least strongly damped or completely prevented.

In a specific exemplary embodiment, the flexure can couple the stator and the rotor together. The flexure supports the rotor (together with the object) and ensures a rigid connection in the z-direction, while the bending element enables movement about at least one axis (tilting axis) perpendicular to the z-direction. Further components would not be necessary in view of the simple and compact design of the device. The rigidity of the movement around the tilting axis is defined by the elasticity of the bending element. The elasticity is defined by the modulus of elasticity of the material used for the bending element and its geometric dimensions.

Furthermore, with regard to a particularly stable arrangement and secure positioning of the rotor and thus the object, the flexure can have a flat flexure. Such a flat flexure can serve to prevent or contain unwanted torsional movements of the rotor about a longitudinal axis (z-axis) of a rod flexure.

In a particularly simple design, the flat flexure can substantially be designed as a disk with flexible arms. Such a flat flexure can be arranged in an x-y plane if a longitudinal direction of the bending element or rod flexure is arranged in a z-direction.

The arms can be coupled to a ring to position such a flat flexure. The ring can be part of the flat flexure so that a particularly compact design of the flat flexure is provided. The ring of the flat flexure can be rigidly connected to the stator. The central area of the flat flexure, on the other hand, can be connected to the rotor. This suppresses torsional movements of the rotor around the z-axis and only tilting movements around the x-axis (or, in a two-axis design, also around the y-axis) are possible.

Depending on the application, the object may have or be an optical element in a specific embodiment. Such an optical element may be a lens, a mirror, a prism, etc.

For a controlled movement of the rotor, the device contains at least one sensor that detects the movement of the rotor and closes the control loop. The sensor can be a distance, position or angle sensor. In a specific exemplary embodiment and depending on the application, the at least one sensor can be designed as a capacitive, inductive or non-contact distance sensor operating according to the eddy current measuring principle. Different applications can have different requirements and the most suitable sensor can be selected in each case.

As briefly mentioned above, the at least one sensor can have at least two sensor elements for detecting the movement of the rotor and/or object in at least two different directions independently of one another. This makes it possible to realize a wide range of different applications.

In a particularly advantageous embodiment, the device can have a control device for setting a predeterminable position of the rotor and/or object. This can ensure a high degree of accuracy when obtaining a desired position of the rotor and/or the object.

In another particularly advantageous embodiment, the device can be designed in such a way that the fundamental frequency in the device is below the control bandwidth and that the first parasitic frequencies are above the control bandwidth. It is particularly advantageous if the control bandwidth is in the range above 1 kHz, preferably 1.5 kHz. This allows a particularly fast and targeted movement of the rotor to be achieved.

Exemplary embodiments of the device according to the invention may be referred to as actuator-sensor systems and may comprise one or more sensors in a flat substrate.

In principle, exemplary embodiments can have a clever combination of mechanical, magnetic and electrical components, which together can form an extremely compact, highly dynamic actuator-sensor system with low energy consumption for the controlled movement of a moving element.

### BRIEF DESCRIPTION OF THE FIGURES

There are now various possibilities for advantageously designing and developing the teaching of the present invention. For this purpose, reference should be made, on the one hand, to the following claims and, on the other hand, to the following explanation of preferred exemplary embodiments of the device according to the invention with reference to the drawing. In conjunction with the explanation of the preferred exemplary embodiments with reference to the drawing, generally preferred embodiments and developments of the teaching are also explained. The drawing shows

FIG. 1a a side view, sectioned, of an exemplary embodiment of the device according to the invention,

FIG. 1b a side view, sectioned, of a further exemplary embodiment of the device according to the invention,

FIG. 2 a perspective side view of a further exemplary embodiment of the device according to the invention,

FIG. 3 a schematic top view of a flat flexure for an exemplary embodiment of the device according to the invention and

FIG. 4 a Bode diagram of an exemplary embodiment of the device according to the invention, wherein the exemplary embodiment is realized as a two-axis actuator-sensor system.

FIG. 5 a Bode diagram of an exemplary embodiment of the device according to the invention, wherein the exemplary embodiment is realized as a two-axis actuator-sensor system.

### DETAILED DESCRIPTION OF VARIOUS EMBODIMENTS

Exemplary embodiments of the invention are explained below:

One exemplary embodiment of the device according to the invention in the form of an actuator-sensor system can consist of an electromagnetic actuator, a sensor, a rod flexure and a flat flexure.

In the exemplary embodiment, the actuator consists of an electromagnetic actuator with a stator and rotor, wherein the rotor is the moving element. The stator contains a coil through which current flows, thereby generating a magnetic field. The rotor has a permanent magnet. Movement is generated by the magnetic interaction between the stator and rotor. The rotor as a moving element is guided by a so-called flexure. The rotor also supports the optical element, which is used to shape or deflect light beams. In order to achieve a closed control loop, the system has a sensor that detects the movement of the rotor. The sensor signal is then used in the control system to specifically control the position of the rotor in an open-and/or closed-loop manner.

In detail:

### Stator

In the broadest sense, the stator defines the basic structure of the actuator-sensor system with the housing, the coil and the components that support the rotor and the optical element. It is advantageous if the coil has a preferably soft magnetic core, with which the magnetic field can be amplified and guided.

### Rotor

The rotor can have a permanent magnet on which the Lorentz force of the coils acts. The rotor can also have the optical element.

### Actuator

In a simple case, the actuator can have a stator with only one coil-with or without a core-and a rotor with a permanent magnet. Depending on the polarity of the permanent magnet or the direction of current through the coil, attractive or repulsive forces can be generated. This can already generate a movement in one direction with a change of sign, e.g., “back and forth” or “up and down”. It is more favorable if the stator has two coils and the rotor has two permanent magnets arranged opposite each other. This allows the efficiency to be increased directly by a factor of 2. Furthermore, the permanent magnet of the rotor in conjunction with a ferromagnetic counterpart on the stator exerts a static magnetic force on the rotor, which leads to the desired negative rigidity of the actuator. The ferromagnetic counterpart can be a structural element of the stator, for example the base of the housing or the mounting of the coil. It is particularly advantageous if the soft magnetic core of the coil forms the ferromagnetic counterpart.

### Flexure

The flexure fulfills several functions: Firstly, it supports the rotor and must therefore have a certain stability and rigidity. Secondly, it must be sufficiently flexible to allow mechanical movement of the rotor. Thirdly, it should prevent unwanted degrees of freedom so that, for example, the rotor does not strike the housing or other components. In a particularly preferred form, the flexure is made in two parts: A rod flexure, for example in the form of a bending element, is firmly connected to the stator on one side. On the other side is the rotor, which is supported by the rod flexure. A z-axis is defined by the rod flexure. By elastically deforming the rod flexure perpendicular to the z-axis, movements are possible in all directions in the x-y plane—rotationally symmetrical on a circle of 360°—provided that these are not restricted by other mechanical means.

A simple case is a single-axis actuator for a tilting movement around the y-axis, for example, i.e., in the positive or negative direction of the x-axis, with which light beams can be specifically deflected within a plane.

To enable tilting movements in two axes, the actuator-sensor system can be further developed by combining two actuator-sensor systems at an angle, for example 90°. This enables movements around both the y-axis and the x-axis. This allows light beams to be deflected into a cone that is spanned by the achievable angular ranges of the two deflection directions. The arrangement of two actuator-sensor systems with a common rod flexure and flat flexure is particularly advantageous, so that the flexure is designed in two parts. The two-axis system thus consists of a stator with at least two coils, a rotor with at least two permanent magnets, a common rod flexure and flat flexure and a sensor with at least two sensor elements for independent detection of the movement in the two independent directions—x- and y-direction. A differential arrangement is particularly advantageous in that two coils, two permanent magnets and two sensor elements are used for each direction of movement.

Clarification: Tilting movements are controlled movements in which a specific position is approached in a targeted manner. This does not refer to simple movements in the sense of a bistable system with two end positions, possibly determined by mechanical end stops.

The rod flexure has a very high stiffness in the z-direction and supports the rotor against the magnetic forces of the stator. It counteracts the negative rigidity of the magnetic circuit with a positive rigidity. In addition, the flexure contains a flat flexure in the form of a flat disk with flexible arms, with which the disk is attached to a mounting ring. The flat flexure has a very low stiffness in the z-direction, but prevents rotational movements around the z-axis—torsional movements—which would not be prevented by the relatively thin rod flexure alone. By combining flat flexure and rod flexure, a defined positive stiffness can be specifically set so that the fundamental frequency and in particular the higher harmonics achieve the desired dynamics of the overall system. The positive stiffness is set by a suitable design of rod and flat flexure, e.g., by their geometry, rod diameter of the rod flexure, arm lengths or widths of the flat flexure, thickness of the flat flexure, materials used, etc. The positive stiffness is counteracted by the negative stiffness of the actuator, which effectively damps the system. However, the decisive factor is that the design of the actuator only damps the fundamental mode, i.e., it only compensates for the stiffness in the direction of movement, so that only the fundamental resonance is shifted downwards. The parasitic resonances remain above the control bandwidth at the high frequencies achieved by the design, which means that simple and stable control with high dynamics can be achieved. It is particularly advantageous for effective damping if the static magnetic force is designed in such a way that it compensates for the mechanical force of the flexure over a wide range of movement, i.e., the damping is effective over as much of the actuator's control range as possible. This can be achieved by a clever arrangement of the permanent magnet in relation to the ferromagnetic counterpart. Mechanical forces increase with increasing deflection according to the relationship F=−c*x. In contrast, the magnetic force effect increases with decreasing distance (air gap). A constructive measure, whereby the air gap is reduced with increasing deflection (tilting) of the rotor, allows almost constant damping to be achieved over a wide range of movement.

### Optical Element

This is often a mirror attached to the rotor. With the help of the mirror, light beams can be specifically deflected by the actuator-sensor system. To save mass, the rotor can also be coated directly with a reflective layer, such as aluminum or silver. Alternatively, lenses, prisms or other optical elements could be attached to the rotor to deflect or shape the beam.

### Sensor

In order to achieve a particularly compact design, the sensor can be designed as a flat sensor. This enables a flat design of the actuator-sensor system, which is particularly suitable for cramped installation conditions or can be used wherever low mass is required, e.g., in vehicles or aircraft. One sensor is sufficient to detect the movement of the rotor in two directions. However, the use of two sensors in a differential arrangement is more favorable, as this suppresses interference in a known manner and generates a symmetrical signal. Non-contact distance sensors based either on the inductive or eddy current measuring principle or on the capacitive measuring principle are most suitable. These have no influence on the object being measured-in this case the rotor-and have a sufficiently high bandwidth to ensure highly dynamic control of the actuator.

### Control

The actuator-sensor system can contain a controller that allows the position of the rotor to be set precisely. The position of the rotor is measured by the sensor element-controlled variable-and compared with the setpoint-manipulated variable. The control can be implemented relatively simply as there are no parasitic resonances in the system transfer function. In addition, the fundamental frequency only varies by less than +/−20 Hz, or less than +/−10 Hz if the design is particularly favorable, over the tilt range of the rotor. This means that a standard PID controller can be used, for example.

### Further Exemplary Embodiments

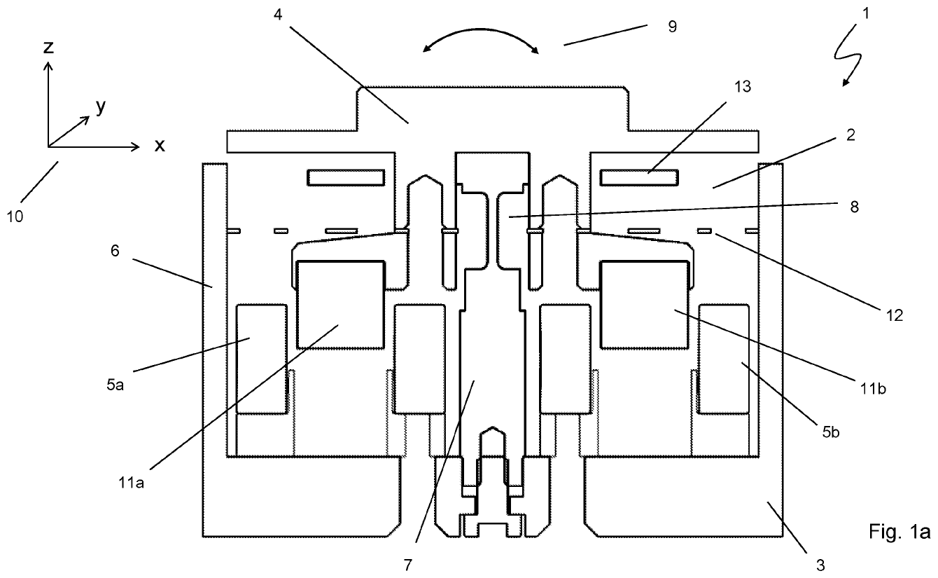

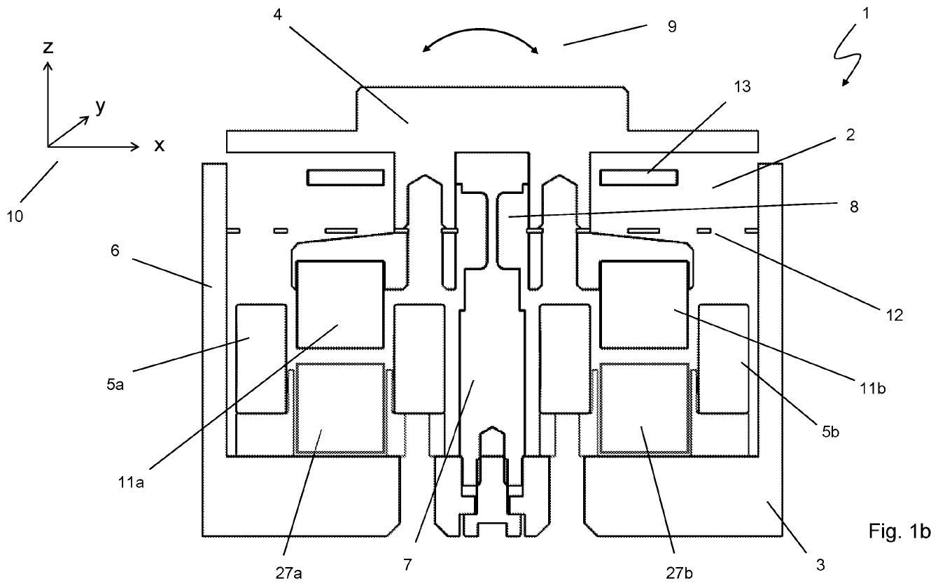

FIG. 1a shows a single-axis actuator-sensor system 1 with particularly high dynamics in a compact design. An actuator 2 consists of a stator 3 and a rotor 4. The stator 3 contains two coils 5a, 5b, which in this example are designed as air coils without a core. The stator 3 also forms a housing 6 of the actuator-sensor system 1. A rod flexure 7 in the form of a bending element and specifically a bending beam is permanently attached to the stator 3. The rod flexure 7 is elastically deformable in the area of a reduced diameter 8. The example shows a tilting movement 9 around the y-axis in the positive and negative x-direction. An axis system 10 is shown at the top left. The rotor 4 contains two permanent magnets 11a, 11b, which together with the coils 5a, 5b generate the dynamic magnetic force effect that moves the rotor 4. Depending on the polarity of the permanent magnets 11a, 11b and the direction of the current flow through the coils 5a, 5b, attractive and repulsive forces are generated which cause the rotor 4 to tilt around the y-axis. The static force effect for damping the system, i.e., to achieve a negative stiffness of the magnetic circuit, is achieved by the permanent magnets 11a, 11b in conjunction with a ferromagnetic structure of the stator 3. In addition to the rod flexure 7, the rotor 4 is also connected to the stator 3, in this case the housing 6, by another flat flexure 12. The flat flexure 12 guides the rotor 4 in a lateral direction—in the x-y plane—and prevents the rotor 4 from hitting the housing 6. Furthermore, the flat flexure 12 prevents torsion of the rod flexure 7, so that only a tilting movement around the y-axis in the positive and negative x-direction 9 is possible. The actuator-sensor system contains a sensor 13 in the form of an eddy current sensor, which is arranged in a flat substrate.

FIG. 1b shows a single-axis actuator-sensor system 1 with particularly high dynamics in a compact design from Figure la, wherein the coils 5a, 5b each have a ferromagnetic core 27a, 27b. The core serves on the one hand to amplify and shape the magnetic flux of the coils 5a, 5b and on the other hand as a counterpart for the permanent magnets 11a, 11b. The static force effect for damping the system, i.e., for achieving a negative stiffness of the magnetic circuit, is achieved by the permanent magnets 11a, 11b in conjunction with the ferromagnetic core 27a, 27b of the coils 5a, 5b.

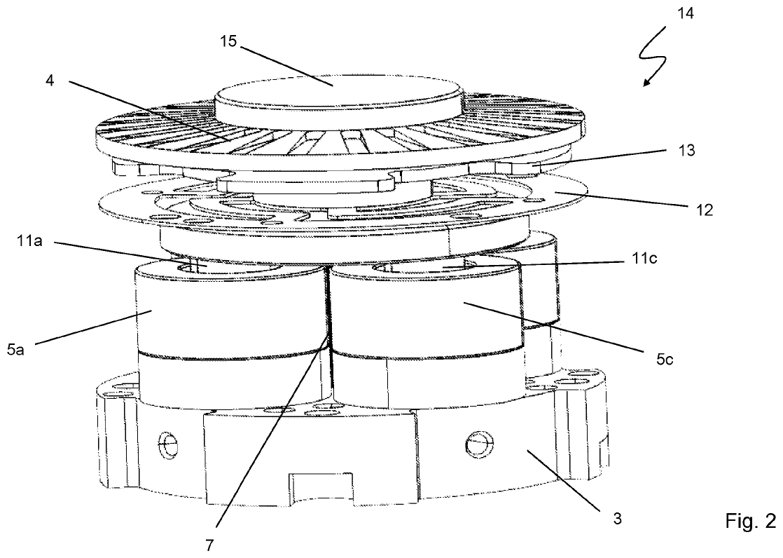

FIG. 2 shows an actuator-sensor system 14 for biaxial movements. In principle, two single-axis actuator-sensor systems 1 are arranged at 90°to each other, wherein some components are used jointly and are therefore only present once: The central rod flexure 7, the flat flexure 12 and the rotor 4 are only required once if designed accordingly. The actuator-sensor system contains four coils-only coils 5a, 5b and 5c are visible-and four permanent magnets-only 11a, 11b and 11c are visible. The sensor 13 contains four coils—not shown—which detect two directions of movement—rotation or pivoting about the x-axis or y-axis—as measuring elements in a differential arrangement. A mirrored area 15 is attached to the rotor 4, which can be used to deflect light beams in a specific spatial direction.

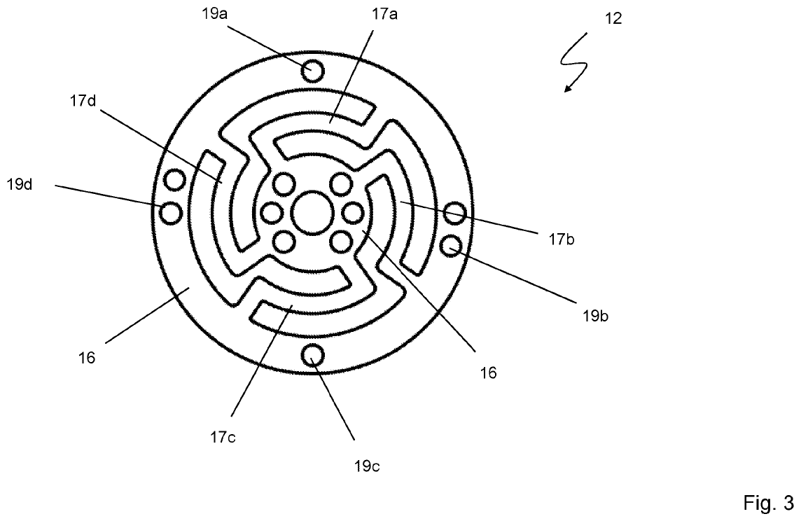

FIG. 3 shows an example of a flat flexure 12 with a central area 16, which is connected to the rotor 4. The central area 16 is connected by four arms 17a, 17b, 17c, 17d to an external fastening ring 18. This is fastened to the stator 3 or the housing 6 or other parts rigidly connected to the stator with screws-not shown-which extend through the holes 19a, 19b, 19c, 19d. The arms 17a, 17b, 17c, 17d are flexible and allow tilting movements around the x-axis or y-axis, but prevent rotations-torsional movements-around the z-axis.

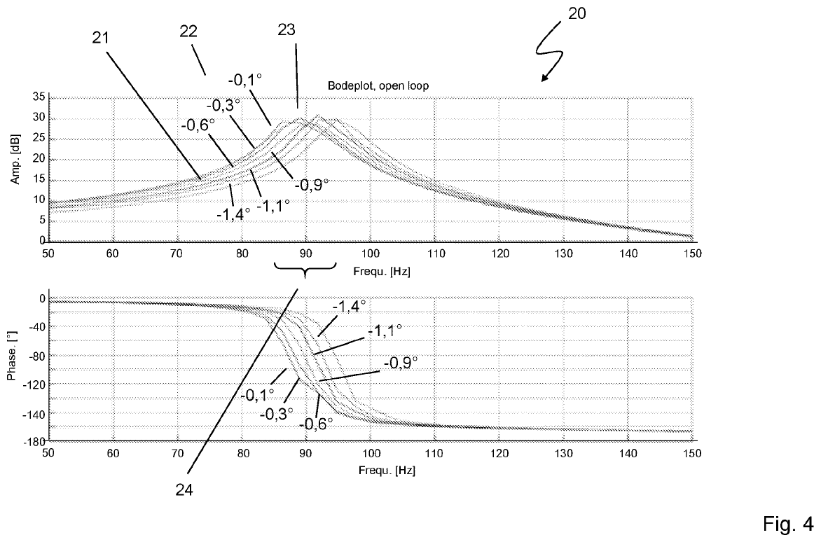

FIG. 4 shows a Bode diagram 20 of a two-axis actuator-sensor system 14 according to the invention with particularly high dynamics. Various transfer functions 21 are shown for different tilts 22 to be controlled in each case. Specifically, transfer functions are shown for tilts of −0.1°, 0.3°, −0.6°, −0.9°, −1.1° and −1.4°. It is important to note that the parasitic modes, which could interfere with or prevent dynamic control, are above 1.5 kHz—no longer visible in the diagram. It is particularly favorable for control if the range of the fundamental resonance 23—which changes with the tilt—varies by less than +/−20 Hz. A change of only +/−10 Hz, as can be seen in this diagram, is particularly favorable, namely in the range 24 from 87 Hz to 94 Hz.

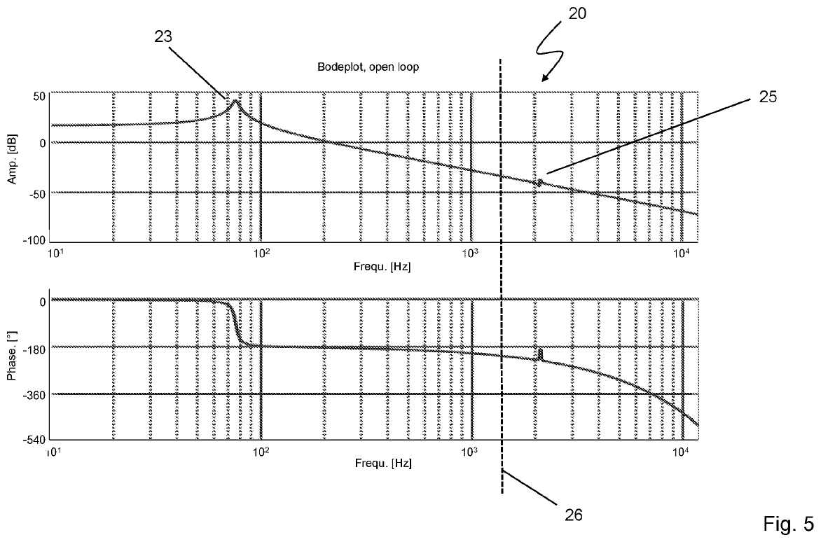

FIG. 5 shows a Bode diagram 20 of a biaxial actuator-sensor system 14 according to the invention with particularly high dynamics with the fundamental resonance 23 and the first harmonic 25, which is around 2 kHz. The control bandwidth 26 of the system is designed for 1.5 kHz. This fulfills the condition for stable control with a simple controller (e.g., PID controller): The fundamental resonance 23 lies below the control bandwidth 26 at a frequency in the range at approximately 80 Hz, the higher harmonics, in particular the first higher harmonic 25 lies above the control bandwidth at approximately 2.1 kHz.

With regard to further advantageous embodiments of the device according to the invention, reference is made to the general part of the description and to the appended claims in order to avoid repetition.

Lastly, it should be expressly pointed out that the exemplary embodiments described above serve only to discuss the claimed teaching, but do not limit it to the exemplary embodiments.

1-17. (canceled)

18. A device for controlling movements of an object in an open-and/or closed-loop manner, wherein the device has an electromagnetic actuator (2), designed to move the object, with a stator (3) and with a rotor (4) coupled to the stator, in an electromagnetically interacting manner, for generating the movement and coupled to the object or supporting the object, a flexure (7, 12) that guides and/or supports the rotor (4) and at least one sensor (13) for detecting a movement of the rotor (4) and/or of the object, wherein a sensor signal of the at least one sensor (13) generated on the basis of a movement of the rotor (4) and/or of the object can be used to control a position of the rotor (4) in an open-and/or closed-loop manner.

19. The device as claimed in claim 18, wherein the flexure (7, 12) is designed with such a high stiffness that parasitic modes lie above a control bandwidth, and in that the actuator (2) has such a negative stiffness that the fundamental frequency is reduced with regard to energy-efficient operation.

20. The device as claimed in claim 18, wherein the stator (3) has at least one coil (5a, 5b).

21. The device as claimed in claim 20, wherein the at least one coil (5a, 5b) has a soft-magnetic core.

22. The device as claimed in claim 18, wherein the rotor (4) has at least one permanent magnet (11a, 11b, 11c).

23. The device as claimed in claim 18, wherein the stator (3) has two coils (5a, 5b) and the rotor (4) has two permanent magnets (11a, 11b, 11c), which are arranged opposite each other.

24. The device as claimed in claim 18, wherein the flexure (7, 12) comprises a bending element.

25. The device as claimed in claim 24, wherein the bending element is a rod flexure (7).

26. The device as claimed in claim 24, wherein the bending element couples the stator (3) and the rotor (4) to one another.

27. The device as claimed in claim 18, wherein the flexure (7, 12) comprises a flat flexure (12).

28. The device as claimed in claim 27, wherein the flat flexure (12) is substantially designed as a disc with flexible arms (17a, 17b, 17c, 17d).

29. The device as claimed in claim 28, wherein the arms (17a, 17b, 17c, 17d) are coupled to a ring (18).

30. The device as claimed in claim 18, wherein the object comprises or is an optical element.

31. The device as claimed in claim 18, wherein the at least one sensor (13) has at least two sensor elements for detecting the movement of the rotor (4) and/or object in at least two different directions independently of one another.

32. The device as claimed in claim 18, wherein the at least one sensor (13) is designed as a sensor (13) operating capacitively, inductively or according to the eddy current measuring principle.

33. The device as claimed in claim 18, wherein the device has a control device for setting a predeterminable position of the rotor (4) and/or object.

34. The device as claimed in claim 18, wherein the device is designed such that a fundamental frequency in the device is in a range up to 1 kHz, and that first parasitic frequencies are above 1.5 kHz.

35. The device as claimed in claim 18, wherein the device is designed such that a fundamental frequency in the device is in a range up to 500 Hz, and that first parasitic frequencies are above 1.5 kHz.

36. The device as claimed in claim 18, wherein the device is designed such that a fundamental frequency in the device is in a range up to 100 Hz, and that first parasitic frequencies are above 1.5 kHz.

37. A method for controlling movements of an object in an open-and/or closed-loop manner via the device of claim 18, wherein the device comprises an electromagnetic actuator (2) designed to move the object and having a stator (3) and a rotor (4) coupled to the stator (3), in an electromagnetically interacting manner, for generating the movement and coupled to the object or supporting the object, a flexure (7, 12) that guides and/or supports the rotor (4) and at least one sensor (13) for detecting a movement of the rotor (4) and/or the object, wherein a sensor signal of the at least one sensor (13) generated on the basis of a movement of the rotor (4) and/or of the object is used to control a position of the rotor (4) in an open-and/or closed-loop manner.
